(19) United States
(12) Patent Application Publication
(10) Pub. No.: US 2025/0234980 A1
(43) Pub. Date: Jul. 24, 2025

(54) EXTENDABLE AND ADJUSTABLE MAGNIFICATION MIRRORS

(71) Applicant: Progress Lighting, LLC, Greenville, SC (US)

(72) Inventors: Palmer Joseph Primm, Greenville, SC (US); John Linkoln Dixon, Greer, SC (US); William Buck Thomas, Greenville, SC (US); David A. Simoni, Greenville, SC (US)

(21) Appl. No.: 19/034,088

(22) Filed: Jan. 22, 2025

Related U.S. Application Data
(60) Provisional application No. 63/624,332, filed on Jan. 24, 2024.

(51) Int. Cl. A45D 42/16; A47G 1/16; G02B 7/198

(52) U.S. Cl. CPC A45D 42/16; A47G 1/1653; G02B 7/198

(57) ABSTRACT

A mirror assembly including a mirror having a fixed mirror portion and an adjustable mirror portion, a frame having a shape that corresponds to at least a portion of the fixed mirror portion and configured to be attached to a structure, the fixed mirror portion being attached to the frame and an adjustable member comprising a proximal end attached to the frame and a distal end attached to the adjustable mirror portion.

### CROSS REFERENCE TO RELATED APPLICATIONS

This application claims priority to U.S. Application Ser. No. 63/624,332 filed on Jan. 24, 2024, which is incorporated herein by reference in its entirety.

### TECHNICAL FIELD

The present disclosure relates generally to mirrors and, more specifically, to extendable and adjustable magnification mirrors.

### DESCRIPTION OF THE RELATED ART

Mirrors are used in many types of situations and environments and come in all shapes, sizes, magnifications, etc. For home use, general purpose mirrors are often provided in which the image is neither magnified (enlarged) or de-magnified (reduced). Such general purpose mirrors are often found in specific areas of a household including, for example, in bedrooms, hallways, rest rooms, etc. While such general purpose mirrors provide a way of obtaining an overall reflection of one's image, they are often insufficient for use for specific purposes including, for example, the application of makeup and other beauty products, which may be applied to the face or hair of the subject.

Vanity, makeup or other magnification type mirrors are often used to aid in the application of beautification products as well as personal grooming of one's skin, hair, etc. Vanity mirrors generally provide a degree of magnification such that the image in the mirror appears larger than it would be in a general purpose mirror.

Vanity mirrors are generally personal mirrors primarily used for grooming, applying makeup, styling hair, etc. They are designed to help an individual look their best and are commonly found in bathrooms, bedrooms, dressing areas, etc. Vanity mirrors can be of various shapes and sizes and may be frameless or may have frames. Vanity mirrors may also come with some type of lighting to provide better reflection and to aid in detailed grooming tasks. In addition to their functional use, vanity mirrors can be attractive and contribute significantly to the aesthetics of a room. Vanity mirrors can be attached to vanity furniture or mounted on the wall. The style and frame of a vanity mirror can be chosen to match the décor of a room.

Users will often utilize multiple types of mirrors to help them perform overall personal grooming. For example, a general purpose mirror with little or no magnification useful for performing general grooming tasks such as arranging one's hair and overall appearance may be provided. A magnified vanity mirror having a magnification factor useful for applying makeup or performing other tasks requiring a magnified view of the user may also be provided.

It will be appreciated that the space requirements and costs associated with providing multiple types of mirrors for personal use may be excessive. A need exists for mirror assemblies that provide the user with the benefits of multiple types of mirrors having different magnification factors in a convenient and compact form.

### SUMMARY OF THE INVENTION

The present disclosure provides implementations of mirror assemblies. In an exemplary implementation, the mirror assembly includes a mirror, a frame and an adjustable member. The mirror has a fixed mirror portion and an adjustable mirror portion, with the fixed mirror portion and the adjustable mirror portion provided in a plane. The frame has a shape that corresponds to at least a portion of the fixed mirror portion and is configured to be attached to a structure, the fixed mirror portion being attached to the frame. The adjustable member includes a proximal end attached to the frame and a distal end attached to the adjustable mirror portion, the adjustable mirror portion movable in a direction transversing the plane. According to a non-limited implementation of the present disclosure, the fixed mirror portion and the adjustable mirror portion have a same magnification factor and, alternatively, the fixed mirror portion and the adjustable mirror portion have different magnification factors. For example, according to an illustrative implementation of the present disclosure, the adjustable mirror portion has a larger magnification factor than the fixed mirror portion. The fixed mirror portion may have no magnification and the adjustable mirror portion may have a magnification factor between 2×-10× or more. The adjustable mirror portion may be adjustable along multiple axis of motion. In a home position, the fixed mirror portion and the adjustable mirror portion are in a same plane. According to an illustrative implementation, the adjustable member is configured to move the adjustable mirror portion in a direction traversing the plane. The adjustable member may include a telescoping member and may include at least one ball-socket assembly. The adjustable member may be attached to the frame via the at least one ball-socket assembly. The adjustable member may attached to the adjustable mirror via the at least one ball-socket assembly.

The present disclosure also provides implementations of mirror assemblies attachable to a structure. The mirror assembly includes a mirror having a first magnification factor, an adjustable arm attached to the mirror and an attachment member for attaching the adjustable mirror assembly to the structure. According to an illustrative implementation of the present disclosure, the first magnification factor is between 2× and 10× or more and the adjustable arm includes at least one of a telescoping member and a gooseneck. The telescoping member and the gooseneck may be joined together at their first ends. A second end of the telescoping member may be attached to a rear surface of the mirror and a second end of the gooseneck may be attached to a connection member. The connection member may be configured to be attached to a structure utilizing at least one of a magnet and a screw. The second end of the telescoping member may be attached to the rear surface of the mirror utilizing a ball-socket assembly.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a front perspective view of a mirror assembly showing a fixed mirror portion and an adjustable mirror portion according to an illustrative implementation of the present disclosure;

FIG. 2 is a front perspective view of the mirror assembly of FIG. 1, illustrating the adjustable mirror portion extended from a home position according to an illustrative implementation of the present disclosure;

FIG. 3 is an exploded perspective view of the mirror assembly of FIG. 1 according to an illustrative implementation of the present disclosure;

FIG. 4 is a front elevation view of a mirror assembly, illustrating the adjustable mirror in a lower central portion of the mirror assembly according to an illustrative implementation of the present disclosure;

FIG. 5 is a cross-sectional view of the mirror assembly of FIG. 4, taken from line 5-5 according to an illustrative implementation of the present disclosure;

FIG. 6 is the cross-sectional view of the mirror assembly of FIG. 5 with the adjustable mirror extended according to an illustrative implementation of the present disclosure;

FIG. 7 is the cross-sectional view of the mirror assembly of FIG. 6 illustrating movement of the adjustable mirror portion according to an illustrative implementation of the present disclosure;

FIG. 8 is the cross-sectional view of the mirror assembly of FIG. 6 illustrating movement of the adjustable mirror portion according to an illustrative implementation of the present disclosure;

FIGS. 9A-9B are enlarged views of a portion of the mirror assembly of FIG. 5 according to an illustrative implementation of the present disclosure;

FIGS. 10-12 are enlarged views of examples of articulating members that may be used to attach portions of illustrative implementations of the present disclosure;

FIG. 13 is an enlarged view of a portion of a telescoping member according to an illustrative implementation of the present disclosure;

FIGS. 14-17 are front views of mirror assemblies in various configurations according to illustrative implementations of the present disclosure;

FIG. 18 is a block diagram of control circuit for optional for the mirror assembly according to an illustrative implementation of the present disclosure;

FIG. 19 is front perspective view of an adjustable magnification mirror attachable to a structure according to an illustrative implementation of the present disclosure attached to a vanity mirror;

FIG. 20 is a perspective view of the adjustable magnification mirror of FIG. 19 according to an illustrative implementation of the present disclosure;

FIG. 21 is a side perspective view of an adjustable magnification mirror attachable to a structure according to another illustrative implementation of the present disclosure;

FIG. 22 is a front view of the adjustable magnification mirror attachable to a structure depicted in FIG. 21 according to an illustrative implementation of the present disclosure; and

FIG. 23 is a rear elevation view of an adjustable magnification mirror attachable to a structure according to another illustrative implementation of the present disclosure.

### DETAILED DESCRIPTION

The present disclosure provides implementations of mirror assemblies that include a fixed mirror and a movable and adjustable magnification mirror. According to an illustrative implementation of the present disclosure, the movable and adjustable magnification mirror is normally positioned in a fixed plane with the fixed mirror. The adjustable magnification mirror can be moved in a direction traversing the fixed plane to a convenient position allowing a user to have a magnified view for performing grooming tasks. The present disclosure also provides implementations of adjustable magnification mirrors attachable to structures including, for example, vanity mirrors or other mirror assemblies.

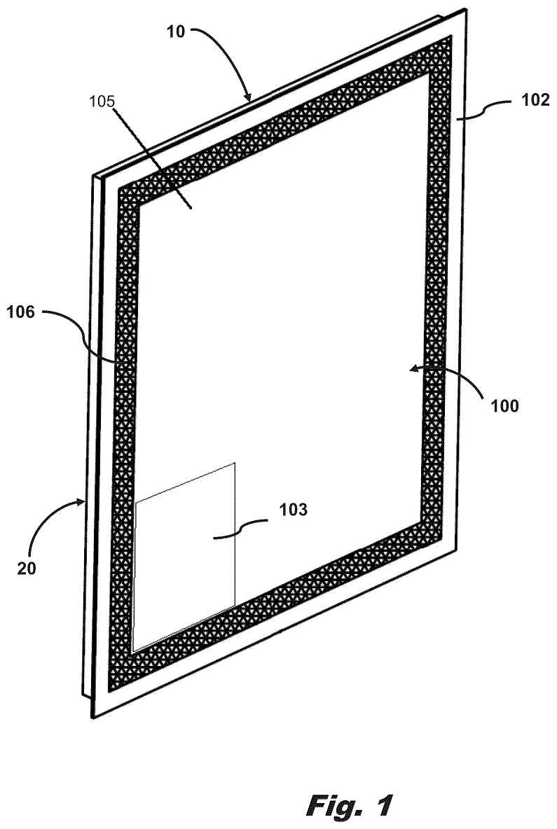

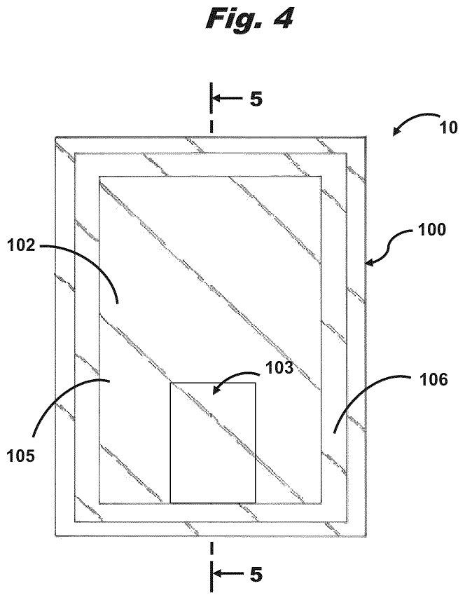

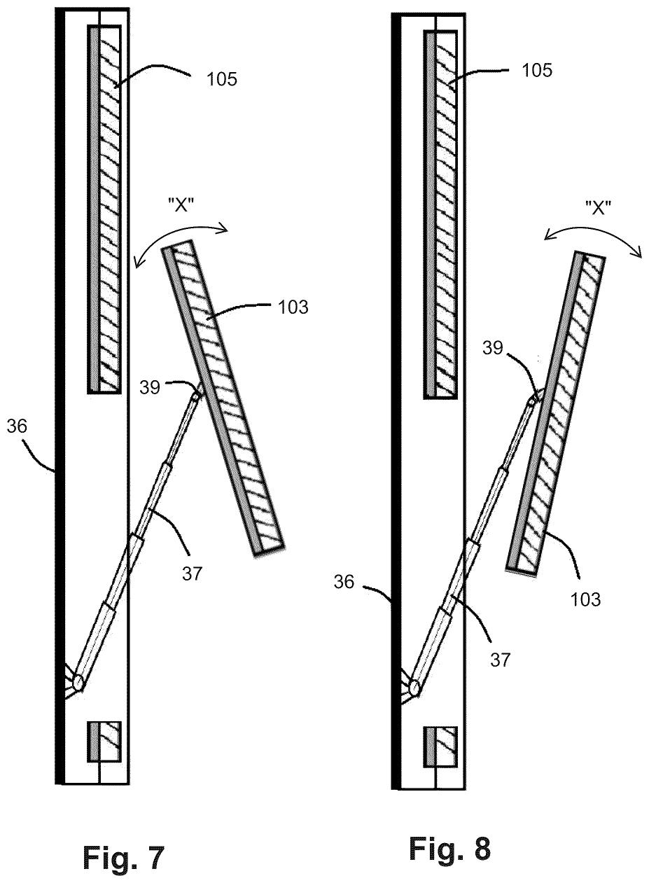

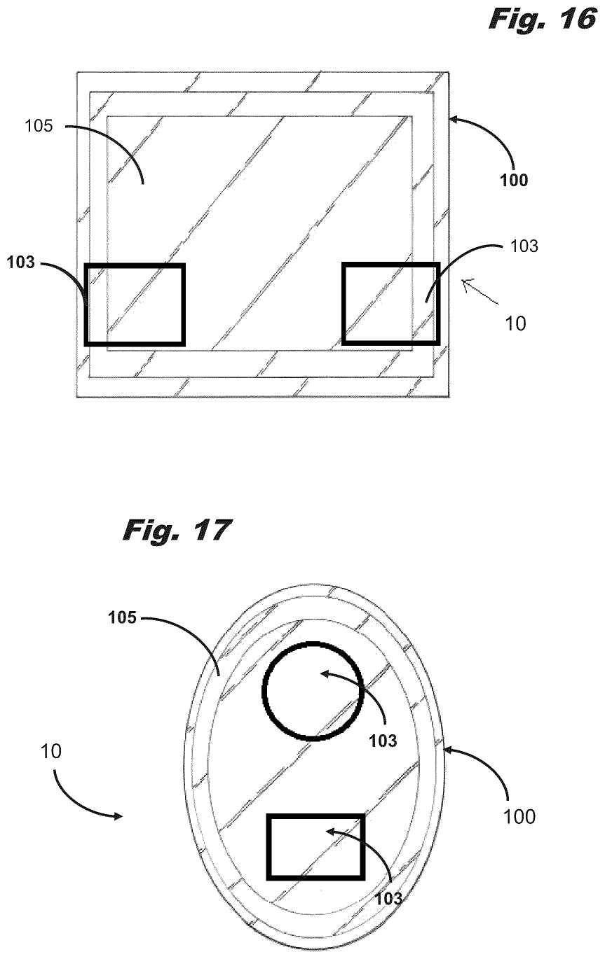

Referring now to FIGS. 1-8, an exemplary implementation of a mirror assembly 10 according to an illustrative implementation of the present disclosure is shown. The mirror assembly 10 includes a frame assembly 20 and a mirror 100. In an exemplary implementation shown, the frame assembly 20 includes a frame 30, an optional light assembly 50 and a mirror bracket 70. The frame assembly 20 can also include a seal member 90. The frame 30 is configured and dimensioned to support the mirror 100 and to conform to the shape of the mirror 100, such that the peripheral dimensions of the frame 30 are the same size or smaller in size than the peripheral dimensions of the mirror 100. Thus, in the implementation of FIGS. 1-8, the frame 30 is configured and dimensioned to support a vertically oriented rectangular mirror 100. In the implementation of FIG. 16, the frame 30 is configured and dimensioned to support a horizontally oriented rectangular mirror 100. In the implementation of FIG. 17, the frame 30 is configured and dimensioned to support a round or oval mirror 100. The frame 30 is configured to be attached to a structure such as a wall. For example, the rear wall 36 of frame 30 can include holes (not shown) which receive screws (not shown) or other attachment members to be used to attach the frame 30 to a structure.

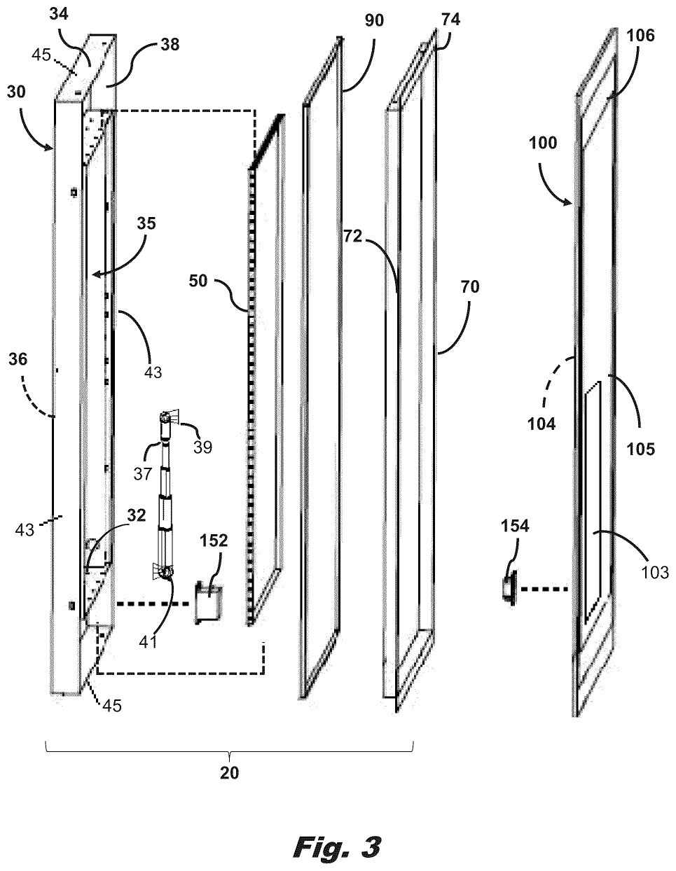

In the exemplary implementation shown in FIGS. 1-8, the frame 30 is configured and dimensioned having an inner wall 32 and an outer wall 34 that is spaced from the inner wall 32. Rear wall 36 extends between the inner wall 32 and the outer wall 34 forming a channel 38 therebetween. The inner wall 32, outer wall 34 and rear wall 36 form a frame 30 having an open central portion 35. In this exemplary implementation, the inner wall 32 can be an integrally or monolithically formed wall. However, the inner wall 32 can be separate wall segments, e.g., side wall segments and end wall segments, joined together by, for example, welds, adhesives and/or mechanical fasteners. Similarly, the outer wall 34 can be an integrally or monolithically formed wall having sides 43 and ends 45. However, the outer wall 34 can be separate wall segments, e.g., side wall segments and end wall segments, joined together by, for example, welds, adhesives and/or mechanical fasteners. Preferably, rear wall 36 is a substantially flat wall. The channel 38 can have a uniform width around the perimeter of the frame 30, or the width of the channel 38 can vary around the perimeter of the frame 30. For example, the width of channel 38 along the side walls of the frame 30 can be smaller than the width of channel 38 along one or both end walls of the frame 30. The optional light assembly 50 is positioned within the channel 38 and is electrically connected to a controller 154. In the implementation shown in FIG. 3, the light assembly 50 is a strip of light emitting diodes, which is also known as an LED strip. The light assembly 50, e.g., the LED strip, is attached to the inner wall 32 of the frame 30 using, for example, adhesive tape and/or tie wraps. The mirror bracket 70 has a wall 72 and a flange 74 formed into or attached to a front edge of the mirror bracket 70. The wall 72 is configured and dimensioned so that the wall 72 can be attached to the outer wall 34 of the frame 30. The flange 74 is used to attach the mirror bracket 70 to the fixed mirror 105 of the mirror 100 using, for example, adhesives. In the event the frame assembly 20 includes the seal member 90, the seal member 90 is positioned on the wall 72 of the mirror bracket 70 so that when the wall 72 is attached to the outer wall 34 of the frame 30, a seal is formed between the wall 72 and/or flange 74 of the mirror bracket 70 and the outer wall 34 of the frame 30 that limits and possibly prevents environmental conditions, e.g., moisture or liquids, from entering the channel 38 of the frame 30. Power and control circuitry 152 for controlling the optional lighting assembly 50 can be provided and will be described in more detail below. The mirror 100 can also include a light emitting portion 106 extending fully or partially around a perimeter of the mirror 100. In the exemplary implementation shown, the light emitting portion 106 extends fully around a perimeter of the mirror 100, as shown in FIGS. 1-4. The light emitting portion 106 can be an area where a reflective layer 104 is removed from the rear side of the mirror 100 so that light within the frame 30 can be emitted through the mirror. The light emitting portion 106 can also be referred to as a lens that can include a dull polished portion of the mirror face 102 and/or can include a translucent strip (not shown) adhered to the rear side of the mirror 100 in the area where the reflective layer 104 is removed. It should be noted that if optional light assembly 50 is not provided, the inner wall 32 of frame 30, power and control circuitry 152, controller 154 and light emitting portion 106 of mirror 100 can be omitted.

Continuing to refer to FIGS. 1-8, mirror 100 has conventional mirror properties that include a face 102 and a reflective layer 104 located on a rear side of the mirror face 102. The mirror can be made of, for example, glass, plastic, etc. The reflective layer 104 can be made of a highly polished metal, such as silver and aluminum, to reflect light. As will be described in more detail below, a first portion of mirror 100 can generally have little to no magnification as is suitable for general use. A second portion of mirror 100 can, depending on preference, have a magnification between 2×-10× or more. In particular, the second portion of mirror 100 can have a magnification suitably selected to provide the user with a detailed view of themselves while performing personal grooming tasks including applying facial beautification or other makeup products, hair styling, etc.

According to an illustrative implementation of the present disclosure, mirror 100 is formed from two mirror portions including fixed mirror 105 and adjustable mirror 103. In the position depicted in FIG. 1, adjustable mirror 103 can be said to be in a home or non-extended position. Fixed mirror 105 and adjustable mirror 103 can each have the same magnification level or each can have a different magnification level. According to an illustrative implementation of the present disclosure, fixed mirror 105 is non-magnified. Alternatively, fixed mirror 105 can have a first magnification factor (e.g., 2X-10X or more). According to an illustrative implementation of the present disclosure, adjustable mirror 103 is magnified and has a magnification factor different than the fixed mirror 105. In particular, the magnification factor of adjustable mirror 103 is generally greater than the non-magnified or first magnification factor of the fixed mirror 105. For example, if fixed mirror 105 has no magnification, adjustable mirror 103 can have a magnification factor of 2×-10× or more. Adjustable mirror 103 is movably attached to frame 30 via arm 37, allowing a user to position adjustable mirror 103 as desired.

Adjustable mirror 103 is attached to frame 30 with arm 37. A proximate end 41 of arm 37 is attached to a portion of frame 30. For example, proximate end 41 of arm 37 can be secured to a side wall or rear wall 36 of frame 30 defining open central portion 35. Proximate end 41 of arm 37 can be attached, for example, by welds, adhesives, screws and/or other suitable mechanical fasteners. A distal end 39 of arm 37 is attached to a rear side of adjustable mirror 103 using, for example, adhesives and/or other suitable mechanical fasteners.

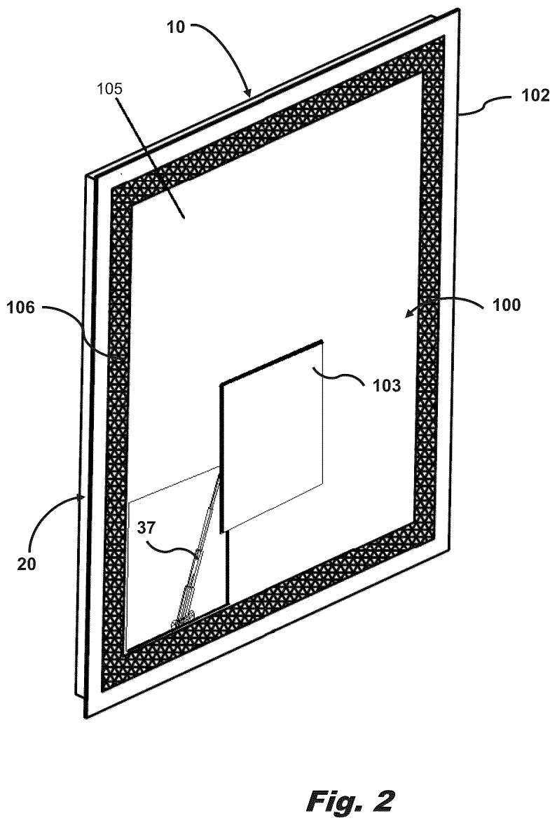

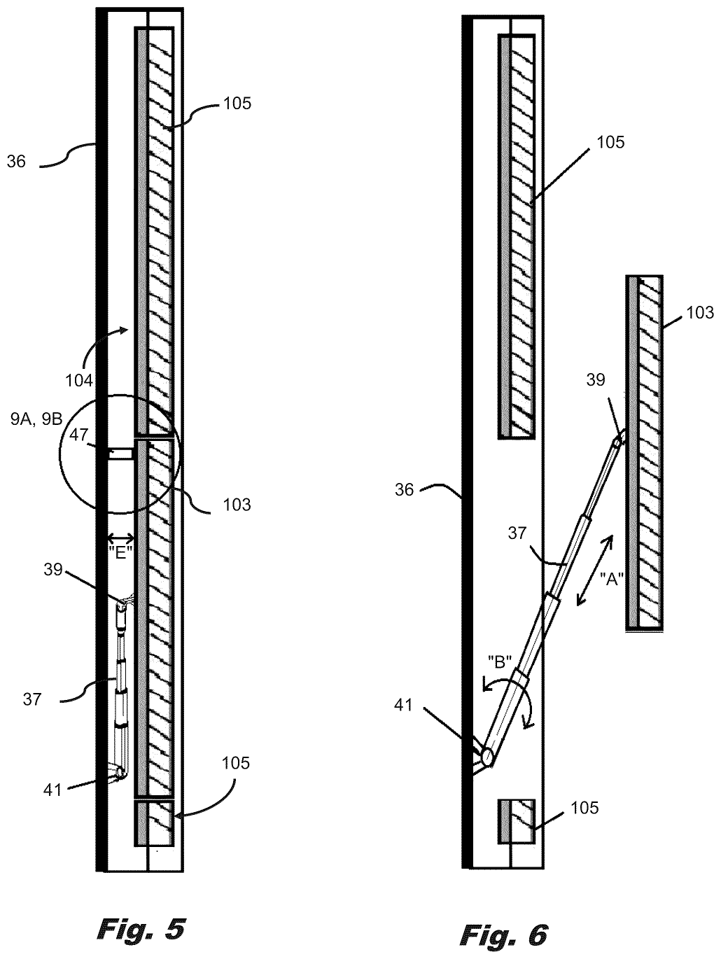

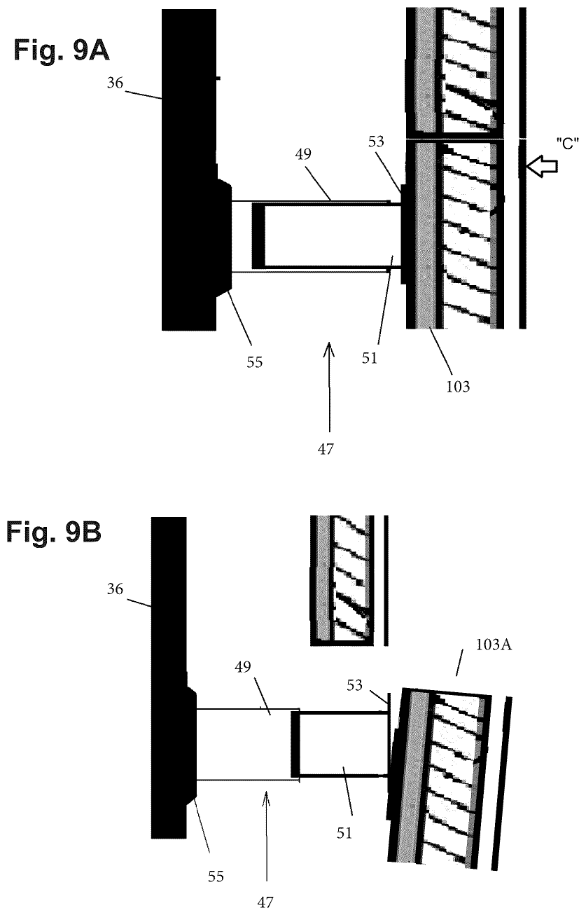

As shown in FIG. 5, when in the home or nonextended position, adjustable mirror 103 is substantially flush with fixed mirror 105 and are in the same plane. One or more standoffs 47 can be fastened to a portion of frame 30 (e.g., rear wall 36). The standoffs 47 abut a rear surface of adjustable mirror 103 maintaining adjustable mirror 103 in the home or nonextended position. According to an illustrative implementation of the present disclosure as shown in FIGS. 9A, 9B, standoff 47 can be a push-to-open type magnetic catch which includes a main body 49 extending from a base 55 and spring-loaded movable member 51. A proximal end of main body 49 includes a base 55. Base 55 can be attached to rear wall 36 of frame 30 by, for example, welds, adhesives, screws and/or other suitable mechanical fasteners. The distal end of spring-loaded movable member 51 includes a magnetic plate 53. A metal plate (not shown) can be attached to the rear surface of adjustable mirror 103 (e.g., by adhesives and/or other suitable mechanical fasteners) and aligned with magnetic plate 53 such that magnetic plate 53 attracts the metal plate and maintains adjustable mirror 103 in position. When movable member 51 is in the retracted position depicted in FIG. 9A and adjustable mirror 103 is pressed in the direction of arrow C and released, the magnetic catch disengages movable arm 51 which then extends under spring action pushing adjustable mirror 103 to the open position as shown in FIG. 9B. This open position allows a user to grasp the top portion 103A of adjustable mirror 103 and extend and adjust it to a desired position as depicted in FIGS. 2 and 6.

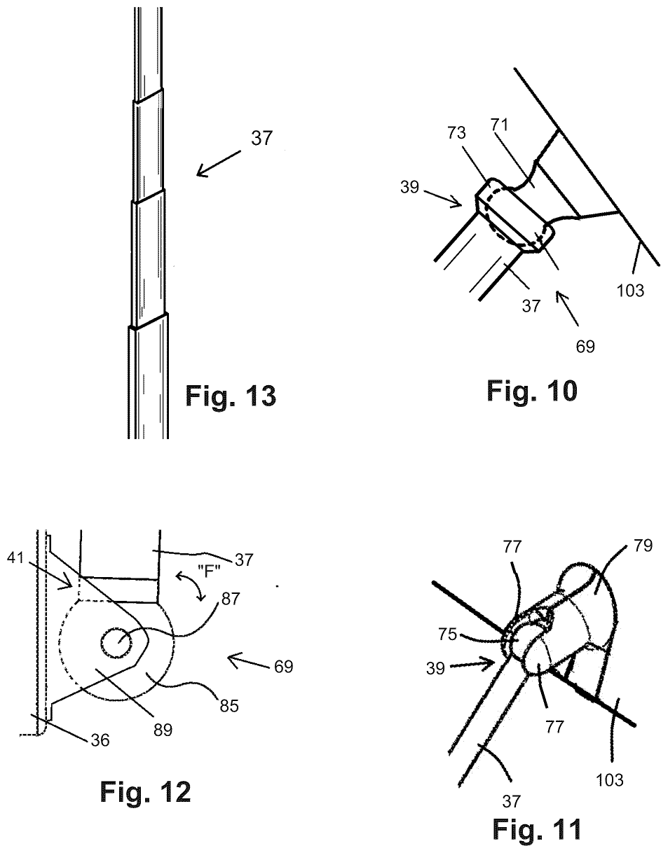

According to an illustrative implementation of the present disclosure, the rear side of adjustable mirror 103 can be pivotably attached to the distal end 39 of arm 37 via attachment member 69, as shown in FIG. 10. Attachment member 69 can be any suitable type of articulating member allowing adjustable mirror to be movably positioned as desired. According to the illustrated implementation of the present disclosure depicted in FIG. 10, attachment member 69 is a ball-socket joint which includes a socket 73 portion attached to distal end 39 of arm 37 and ball portion 71 attached to the rear of adjustable mirror 103. The ball-socket joint allows adjustable mirror 103 to be pivoted and rotated in various directions as desired. Another type of ball-socket joint according to another illustrative implementation of the present disclosure is shown in FIG. 11. In this implementation, the distal end 39 of arm 37 includes a ball shaped member 75. A ball socket arm assembly 79 is attached to the rear of adjustable mirror 103. The ball socket arm assembly 79 includes two or more arms 77 dimensioned to receive ball shaped member 75. The ball-socket joint depicted in FIG. 11 can provide an even greater range of movement of adjustable mirror 103 than the ball-socket joint depicted in FIG. 10. The proximate end 41 of arm 37 can be pivotably attached to frame 30 using ball-socket joints similar to those depicted in FIGS. 10 and 11. Alternatively, the proximate end 41 of arm 37 can be attached to rear wall 36 by a stanchion 89. Stanchion 89 includes a bore 87 which aligns with a bore in proximate end 41 of arm 37. A bolt (not shown) extends through bore 87 and provides an axis of rotation of arm 37 in the directions indicated by arrows “F”.

Arm 37 can be a single section of material of a length so that adjustable mirror 103 extends a sufficient distance from the mirror assembly 10 when adjustable mirror 103 is rotated outward to the open position. Generally, such a sufficient distance will provide the user with an easy view for applying beautification or other makeup products and/or for performing other self-grooming tasks. Alternatively, arm 37 can be formed from two or more sections of material joined to form a telescoping member 37 as shown in FIGS. 1-8. The telescoping arm 37 provides the user with a great degree of versatility and adjustability of the adjustable mirror 103. For example, the telescoping arm 37 allows the adjustable mirror to be adjusted to various heights and allows the adjustable mirror 103 to be moved further from the rest of the mirror assembly 10 and closer to the user for an even better view for easier application of makeup products and self-grooming. Arm 37 can be formed from one or more sections of round tubular sections of material as shown in FIGS. 5 and 6 which provides additional versatility of the adjustable mirror 103 allowing it to rotate around the longitudinal axis formed by arm 37. Alternatively, as depicted in FIG. 13, arm 37 can be formed from one or more sections of substantially flatter rectangular tubular sections. It will be appreciated that the telescoping arm depicted in FIG. 13 would allow the depth “E” (e.g., see FIG. 5) of mirror assembly 10 to be made shallower than is possible with a telescoping member having round tubular sections.

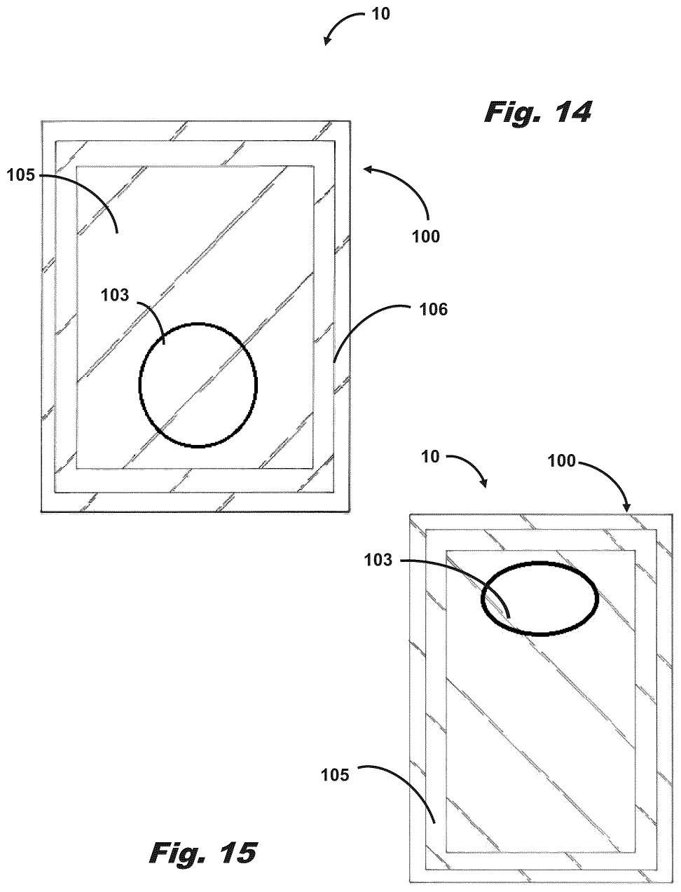

Many different configurations of mirror assembly 10 are possible, just a few of which are shown herein. For example, the adjustable mirror 103 can be provided in many shapes and sizes and can be provided in different positions as shown in FIGS. 14-16. For example, as shown in FIGS. 14 and 15, the adjustable mirror 103 can be round or oval and can be positioned in any of various positions including in a lower or bottom portion (FIG. 14) or in an upper or top portion (FIG. 15) of the mirror assembly or anywhere in between. The mirror assembly 10 can be arranged horizontally as depicted in FIG. 16. Any of the mirror assemblies described herein can include a plurality of adjustable mirrors 103 as illustrated in FIG. 16. Each of the plurality of adjustable mirrors 103 can have the same or different magnification factors. As shown in FIG. 17, the mirror assembly 10 can be round or oval and can include one or more adjustable mirrors 103 of various shapes, sizes and magnification levels.

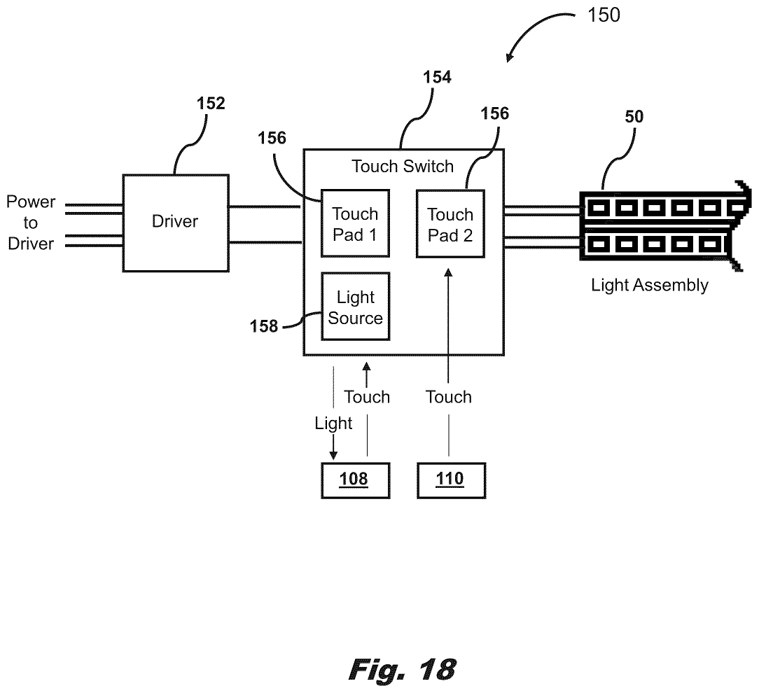

Referring now to FIG. 18, a block diagram of an exemplary optional capacitive touch control system for controlling the optional light assembly 50 according to an illustrative implementation of the present disclosure is shown and described. The optional capacitive touch control system 150 includes a driver 152 and a capacitive touch controller 154. The driver 152 converts 120 v AC power to a voltage suitable for the optional light assembly 50 of the frame assembly 30. In the implementation where the light assembly 50 is an LED strip, the driver 152 can be an LED driver, such as the XLG-150-12-A LED driver, manufactured by Mean Well USA, Inc. of Fremont, California, which is incorporated herein in its entirety by reference. The touch controller 154 can include one or more built-in or embedded light emitting diodes (LEDs) (not shown). The touch controller 154 controls power from the driver 152 to the light assembly 50 and the one or more LEDs 158.

In the exemplary implementation shown herein, the touch controller 154 is a capacitive touch controller. The capacitive touch controller 154 can have one or more built-in touch pads 156 adjacent to the exterior surface of the capacitive touch controller 154. The capacitive touch controller 154 can be positioned against the rear side of the mirror 100, so that touch pads 156 of the capacitive touch controller 154 are located over specific touch areas 108, 110 of the mirror 100. The capacitive touch controller 154 can be adhered to the rear side of the mirror 100 using, for example, adhesives or adhesive strips. The reflective layer 104 is preferably partitioned into one or more touch areas 108 and 110. For example, according to an exemplary implementation of the present disclosure, the one or more touch areas 108 and 110 are openings or holes 112 formed in the reflective layer 104 on the rear surface of mirror 100, such that no reflective material is on these portions of the rear side of the mirror 100. Thus, the touch areas 108 and 110 are electrically isolated from the reflective layer 104. The opening 112 of each touch area 108 or 110 can or can not be visible on the face of the mirror 100.

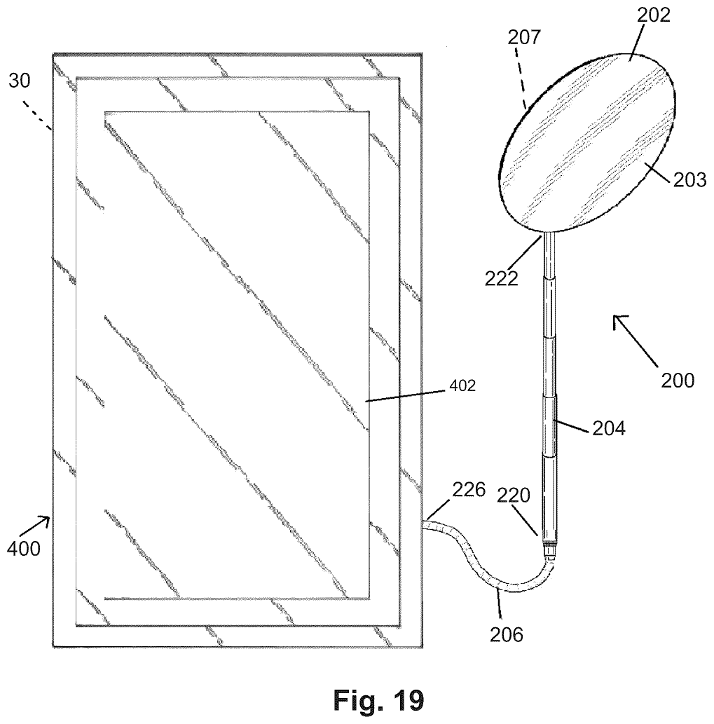

Referring now to FIGS. 19-23 exemplary implementations of adjustable mirror assemblies that can be attached to a main mirror are shown. The adjustable mirror assemblies can be magnified if desired. The adjustable magnifying mirror assemblies as described herein with respect to FIGS. 19-23 can be attached to a vanity mirror or other main mirror assembly 400 used to perform personal grooming tasks including applying facial beautification or other makeup products, hair styling, etc. The vanity mirror or other mirror assembly 400 can include a frame 30 and similar to that described above with respect to FIGS. 1-8 and a main mirror 402.

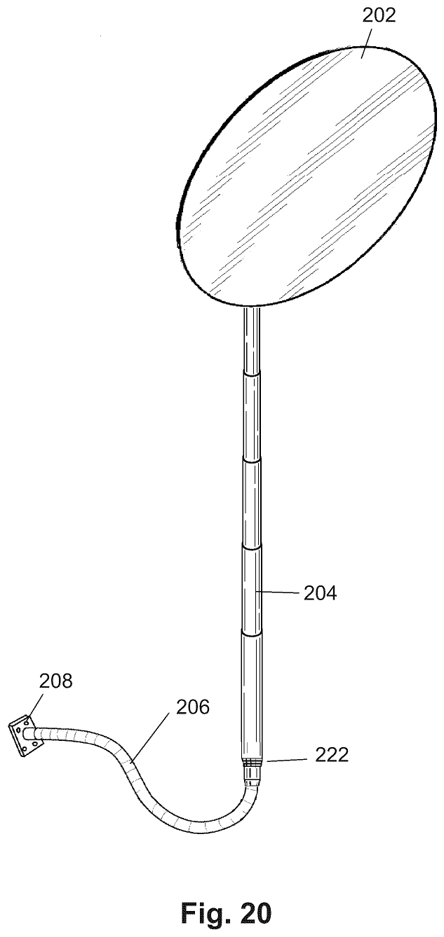

According to an illustrative implementation of the present disclosure as shown in FIGS. 19 and 20, adjustable magnifying mirror assembly 200 includes a mirror 202, arm 204, adjustable member 206 and attachment bracket 208. Mirror assembly 200 can be attached to an exterior surface of the frame 30 of mirror assembly 400 including, for example, a side wall 43 of frame 30. According to an illustrative implementation, a distal end 222 of arm 204 is attached to the rear side of mirror 202 utilizing one or more of the articulating attachments described above with respect to FIGS. 10-12. Attachment can be made utilizing adhesives and/or other suitable mechanical fasteners. A proximate end 220 of arm 204 is attached to a distal end of adjustable member 206. Adjustable member 206 can be a gooseneck which is a resiliently bendable material. More specifically, a gooseneck is a semi-rigid, flexible element made from a coiled metal hose which can be bent in multiple directions and remain in that position. Adjustable member 206 is positionable by the user in a selected shape and will retain that shape until readjusted. Adjustable member 206 can generally have a length ranging from 1 inch to 20 inches. The proximate end 226 of adjustable member 206 is attached to attachment bracket 208. Attachment bracket 208 can include a magnet such as, for example, a rare earth magnet such that the attachment bracket 208 can be magnetically attached to metal frame 30 of mirror 400. Alternatively, or in addition, attachment bracket 208 can include one or more screw holes so that appropriately sized screws (not shown) can be used to attach the adjustable mirror assembly 200 to mirror assembly 400. According to another implementation, attachment bracket 208 can be attached to a face of the main mirror 402 of mirror assembly 400 utilizing double-sided tape or other suitable fastener.

Mirror 202 is similar to other mirrors described above and has conventional mirror properties that include a mirror face 203 and a reflective layer 207 located on a rear side of the mirror face 203. The mirror 202 can be made of, for example, glass, plastic, etc. The reflective layer 207 can be made of a highly polished metal, such as silver and aluminum, to reflect light. Mirror 202 can generally have little to no magnification as is suitable for general use. Alternatively, mirror 202 can, depending on preference, have a magnification between 2×-10× or more. In particular, the mirror 202 can have a magnification suitably selected to provide the user with a detailed view of themselves while performing personal grooming tasks including applying facial beautification or other makeup products, hair styling, etc.

Although depicted as oval or round, mirror 202 can be provided in any other suitable shape including, for example, square, rectangular, triangular, oblong, etc. Arm 204 can be a single section of material of sufficient length so that mirror 202 extends a sufficient distance from the mirror assembly 400 when adjustable arm 206 is moved away from mirror assembly 400. Generally, such a sufficient distance will provide the user with an easy view for applying beautification or other makeup products and/or for performing other self-grooming tasks. Alternatively, the arm 204 can be formed from two or more sections of material joined to form a telescoping member similar to the telescoping members described above with respect to previous implementation shown in FIGS. 1-8. A telescoping arm 204 provides the user with an additional degree of versatility and adjustability of the adjustable mirror 202. In particular, telescoping arm 204 allows the adjustable mirror 202 to be rotated and adjusted to various heights and allows the mirror 202 to be moved further from the mirror assembly 400 and closer to the user for a better close-up view when applying makeup products and performing self-grooming. The Arm 204 can be formed from one or more sections of round tubular sections of material as shown in FIGS. 5 and 6. Alternatively, as depicted in FIG. 13, the arm 204 can be formed from one or more sections of substantially flatter rectangular tubular sections.

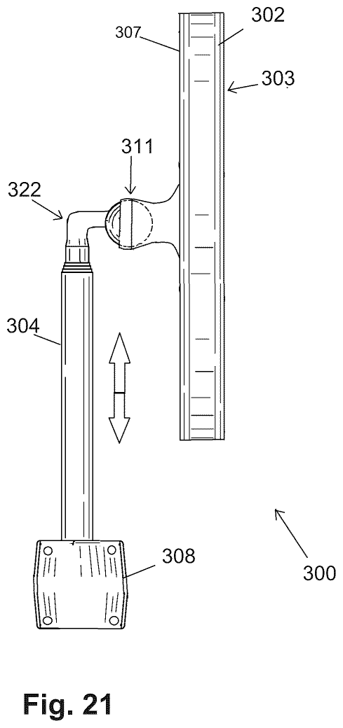

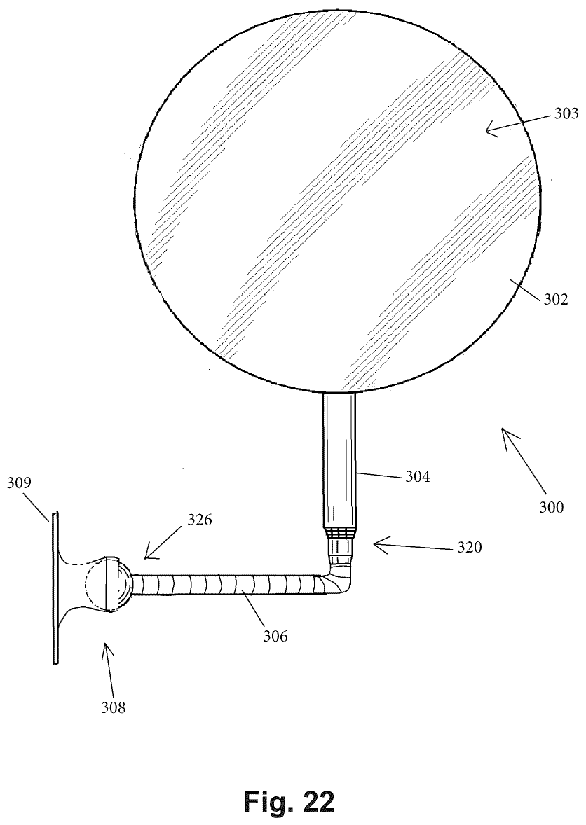

An adjustable magnifying mirror assembly according to another illustrative implementation of the present disclosure as shown in FIGS. 21 and 22 and is referred to as adjustable magnifying mirror assembly or just mirror assembly 300. Mirror assembly 300 includes a mirror 302, arm 304, arm 306 and attachment member 308 and 311. Attachment members 308 and 311 are ball-socket type members similar to those described above with respect to FIGS. 10 and 11. Attachment member 308 can be attached to an exterior side surface of the frame 30 of mirror assembly 400. A distal end 322 of arm 304 is attached to the rear side of mirror 302 via attachment member 311. A proximate end 320 of arm 304 is attached to a distal end of arm 306. The arm 306 can be a solid portion of material or can be a gooseneck which is a resiliently bendable material as described above. Using a gooseneck, arm 306 is positionable by the user in a selected shape and will retain that shape until readjusted. The arm 306 can generally have a length ranging from 2 inches to 20 inches. The proximate end 326 of arm 306 is attached to attachment member 308 which in this implementation is a ball-socket type member. Attachment member 308 can include a magnet 309 such as, for example, a rare earth magnet so that the attachment member 308 can be magnetically attached to metal frame 30 of mirror 400. Alternatively, or in addition, attachment member 308 can include one or more screw holes so that appropriately sized screws (not shown) can be used to attach the adjustable mirror assembly 300 to mirror assembly 400. According to another implementation, attachment member 208 can be attached to a face of the mirror 402 of mirror assembly 400 utilizing double-sided tape or other suitable fastener.

Mirror 302 has conventional mirror properties that include a mirror face 303 and a reflective layer 307 located on a rear side of the mirror face 303. The mirror 302 can be made of, for example, glass, plastic, etc. The reflective layer 307 can be made of a highly polished metal, such as silver and aluminum, to reflect light. Mirror 302 can generally have little to no magnification as is suitable for general use. Alternatively, mirror 302 can, depending on preference, have a magnification between 2×-10× or more. In particular, the mirror 302 can have a magnification suitably selected to provide the user with a detailed view of themselves while performing personal grooming tasks including applying facial beautification or other makeup products, hair styling, etc.

Although depicted as oval or round, mirror 302 can be provided in any other suitable shape including, for example, square, rectangular, triangular, oblong, etc. The arm 304 can be a single section of material of sufficient length so that mirror 302 extends a sufficient distance from the mirror assembly 400 when adjustable arm 306 is moved away from mirror assembly 400 towards the user. Generally, such a sufficient distance will provide the user with an easy view for applying beautification or other makeup products. Alternatively, the arm 304 can be formed from two or more sections of material joined to form a telescoping member similar to the telescoping members described above with respect to previous implementations described above. A telescoping arm 304 provides the user with an additional degree of versatility and adjustability of the adjustable mirror 302. In particular, telescoping arm 304 allows the adjustable mirror 302 to be adjusted to various heights and allows the adjustable mirror 302 to be moved further from the mirror assembly 400 and closer to the user for a better close-up view when applying makeup products and performing self-grooming. The arm 304 can be formed from one or more sections of round tubular sections of material as shown in FIGS. 5 and 6. Alternatively, as depicted in FIG. 13, the arm 304 can be formed from one or more sections of substantially flatter rectangular tubular sections.

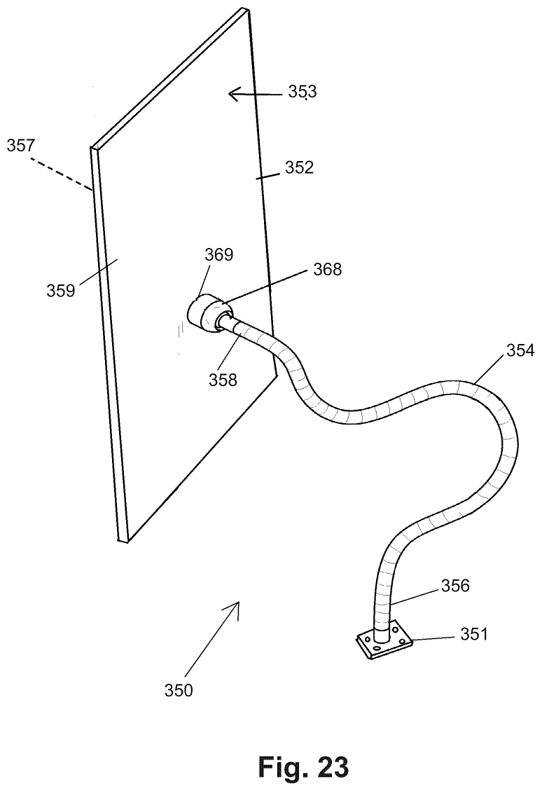

An adjustable magnifying mirror assembly according to another illustrative implementation of the present disclosure as shown in FIG. 23 and is referred to as adjustable magnifying mirror assembly or just mirror assembly 350. Mirror assembly 350 includes a mirror 352, arm 354 and attachment members 368 and 351. Attachment members 368 and 351 can be ball-socket type members similar to those described above with respect to FIGS. 10 and 11. According to the present illustrated implementation, attachment member 351 is a simple non-articulating attachment bracket 351 and is attached to the proximal end 356 of arm 354. Attachment bracket 351 can include a magnet such as, for example, a rare earth magnet (not shown) so that the attachment bracket 351 and mirror assembly 350 can be magnetically attached to metal frame 30 of mirror 400 depicted in FIG. 19. Alternatively, or in addition, attachment bracket 351 can include one or more screw holes so that appropriately sized screws (not shown) can be used to attach the adjustable mirror assembly 350 to mirror assembly 400. According to another implementation, attachment bracket 351 can be attached to a face of the mirror 402 of mirror assembly 400 utilizing double-sided tape or other suitable fastener. A distal end 358 of arm 354 is attached to the rear side 353 of mirror 352 via attachment member 368. Attachment member 368 can be a non-articulating attachment bracket or can be an articulating member such as a ball-socket type member depicted in FIGS. 10 and 11. Arm 354 is a gooseneck which is a resiliently bendable material as described above. Using a gooseneck, arm 354 is positionable by the user in a selected shape and will retain that shape until readjusted. Arm 354 can generally have a length ranging from 6 inches to 20 inches.

Mirror 352 has conventional mirror properties that include a mirror face 357 and a reflective layer 359 located on a rear side 353 of the mirror face 357. The mirror 352 can be made of, for example, glass, plastic, etc. The reflective layer 359 can be made of a highly polished metal, such as silver and aluminum, to reflect light. Mirror 352 can generally have little to no magnification as is suitable for general use. Alternatively, mirror 352 can, depending on preference, have a magnification between 2×-10× or more. In particular, the mirror 352 can have a magnification suitably selected to provide the user with a detailed view of themselves while performing personal grooming tasks including applying facial beautification or other makeup products, hair styling, etc.

Although depicted as square or rectangular, mirror 352 can be provided in any other suitable shape including, for example, round, oval, triangular, oblong, etc. Gooseneck arm 354 can be a single section of material of sufficient length so that mirror 302 extends a sufficient distance from the mirror assembly 400 when gooseneck arm 354 is moved away from mirror assembly 400. Generally, such a sufficient distance will provide the user with an easy view for applying beautification or other makeup products. In particular, gooseneck arm 354 allows the adjustable mirror 352 to be adjusted to various heights and allows the adjustable mirror 352 to be moved further from the mirror assembly 400 and closer to the user for a better close-up view when applying makeup products and performing self-grooming.

As shown throughout the drawings, like reference numerals designate like or corresponding parts. While exemplary implementations of the present disclosure have been described herein and shown in the accompanying drawings, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

Certain terminology may be used in the present disclosure for ease of description and understanding. Examples include the following terminology or variations thereof: up, upward, upper, top, inner, outer, down, downward, bottom, lower, etc. These terms refer to directions in the drawings to which reference is being made and not necessarily to any actual configuration of the structure or structures in use and, as such, are not necessarily meant to be limiting.

What is claimed is:

1. A mirror assembly comprising:
a mirror having a fixed mirror portion and an adjustable mirror portion, the fixed mirror portion and the adjustable mirror portion provided in a plane;
a frame having a shape that corresponds to at least a portion of the fixed mirror portion and configured to be attached to a structure, the fixed mirror portion being attached to the frame; and
an adjustable member comprising a proximal end attached to the frame and a distal end attached to the adjustable mirror portion, the adjustable mirror portion movable in a direction transversing the plane.

2. The mirror assembly as recited in claim 1, wherein the fixed mirror portion and the adjustable mirror portion have a same magnification factor.

3. The mirror assembly as recited in claim 1, wherein the fixed mirror portion and the adjustable mirror portion have different magnification factors.

4. The mirror assembly as recited in claim 3, wherein the adjustable mirror portion has a larger magnification factor than the fixed mirror portion.

5. The mirror assembly as recited in claim 4, wherein the fixed mirror portion has no magnification and the adjustable mirror portion has a magnification factor between 2×-10× or greater.

6. The mirror assembly as recited in claim 1, wherein the adjustable mirror portion is adjustable along multiple axis of motion.

7. The mirror assembly as recited in claim 1, wherein in a home position, the fixed mirror portion and the adjustable mirror portion are in a same plane.

8. The mirror assembly as recited in claim 1 wherein the adjustable member is configured to move the adjustable mirror portion in a direction traversing the plane.

9. The mirror assembly as recited in claim 1, wherein the adjustable member comprises a telescoping member.

10. The mirror assembly as recited in claim 9, wherein the adjustable member further comprises at least one ball-socket assembly.

11. The mirror assembly as recited in claim 10, wherein the adjustable member is attached to the frame via the at least one ball-socket assembly.

12. The mirror assembly as recited in claim 11, wherein the adjustable member is attached to the adjustable mirror via the at least one ball-socket assembly.

13. An adjustable mirror assembly attachable to a structure, comprising:
a mirror having a first magnification factor;
an adjustable arm attached to the mirror; and
an attachment member for attaching the adjustable mirror assembly to the structure.

14. The adjustable mirror assembly as recited in claim 13, wherein the first magnification factor is between 2× and 10× or greater.

15. The adjustable mirror assembly as recited in claim 13, wherein the adjustable arm comprises at least one of a telescoping member and a gooseneck.

16. The adjustable mirror assembly as recited in claim 15, wherein the telescoping member and the gooseneck are joined together at their first ends.

17. The adjustable mirror assembly as recited in claim 16, wherein a second end of the telescoping member is attached to a rear surface of the mirror.

18. The adjustable mirror assembly as recited in claim 17, wherein a second end of the gooseneck is attached to a connection member.

19. The adjustable mirror assembly as recited in claim 18, wherein the connection member is configured to be attached to a structure utilizing at least one of a magnet and a screw.

20. The adjustable mirror assembly as recited in claim 16, wherein the second end of the telescoping member is attached to the rear surface of the mirror utilizing a ball-socket assembly.
